(19) United States
(12) Patent Application Publication
(10) Pub. No.: US 2010/0073795 A1
(43) Pub. Date: Mar. 25, 2010

(54) FLYING HEIGHT CONTROL DEVICE FOR MAGNETIC HEAD, AND MAGNETIC DISK DEVICE

(75) Inventor: Ryoichi Amano, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/507,615

(22) Filed: Jul. 22, 2009

(30) Foreign Application Priority Data
Sep. 25, 2008 (JP) 2008-246280

(51) Int. Cl. G11B 27/36; G11B 21/02

(52) U.S. Cl. 360/31; 360/75; G9B/21.003; G9B/21.011

(57) ABSTRACT

A flying height control device controls a flying height of a magnetic head, while preventing unnecessary execution of flying height control when read performance drops. A control circuit, which controls the flying height by controlling the heat power of a heater element of a magnetic head, checks the read performance, detects a drop in read performance, then judges and discerns which the cause of the drop in read performance is in the magnetic head and the magnetic disk, and executes the flying height control by the heat power correction processing when judging that the cause of the drop in read performance is in the magnetic head. Thus unnecessary adjustment while the magnetic disk device is operating is prevented.

### CROSS-REFERENCE TO RELATED APPLICATIONS

This application is based upon and claims the benefit of priority of the prior Japanese Patent Application No. 2008-246280, filed on Sep. 25, 2008, the entire contents of which are incorporated herein by reference.

### FIELD

The present invention relates to a flying height control device and a magnetic disk device for controlling the flying height of a magnetic head from a magnetic disk surface, so as to improve read characteristics, and more particularly to a flying height control device and magnetic disk device of a magnetic head for controlling the flying height using a heater element installed in the magnetic head.

### BACKGROUND

In order to implement high recording density of a magnetic disk device, a flying height of a head from a recording surface of a magnetic disk must be decreased. Recently a 5 nm order of flying height has been implemented.

A magnetic disk device is used not only for notebook type personal computers but also for portable and mobile equipment, and reliability of the magnetic disk device is demanded under a high temperature and humid environment. The flying height of a recording/reproducing element of a magnetic head, which has a major influence on reliability, drops by thermal expansion around the recording/reproducing element at high temperature, and drops by a decrease in positive pressure which acts on the magnetic head in high humidity.

When the flying height of the magnetic head drops, the head more easily collides with the micro-protrusions on the magnetic disk surface, and the dispersion of the clearance among each head, which exists within the tolerance of the mechanism, cannot be set lower than the tolerance of the flying height, if the above mentioned contact with media is considered.

In order to prevent this drop of flying height in a high temperature and high humidity environment, a magnetic disk device, having a function to adjust a flying height according to the environment, has been proposed. In other words, a method of controlling the clearance between the head and the recording surface of the magnetic disk using a phenomena of the floating side of the head protruding in the magnetic disk direction (thermal protrusion: TPR) which encloses a heater in a magnetic head and thermally expands the magnetic head by turning the heater ON, has been proposed (e.g. see Japanese Patent Application Laid-Open No. 2006-269005).

In the test step for a magnetic disk device, the optimum MR bias, write current and parameters of the read channel, for example, are individually adjusted for magnetic heads and magnetic disks. In this adjustment, the heater power is adjusted such that the spacing becomes constant (e.g. 5 nm) at high temperature, normal temperature and low temperature. These adjustment values are held in the magnetic disk device.

In the operation of a magnetic disk device after shipment, an environment temperature of the magnetic disk is detected, corresponding heater power is calculated, and a heater element is driven by a calculated heater power so that the flying height is maintained to be constant.

It has also been proposed that the read error rate is monitored in order to prevent fluctuation of the flying height due to the change in air pressure during operation, and the heater power to the heater element is corrected when the read error rate deteriorates, so as to prevent fluctuation of the flying height of the magnetic head (e.g. see Japanese Patent Application Laid-Open No. 2007-310957).

In the prior art, the magnetic disk device itself monitors the read error rate by the internal processing of the device, and changes the heater power when it is judged that the read error rate is deteriorated, so that the change of the flying height is prevented by self recovery.

In other words, in the case of prior art, the heater power is changed without checking the cause of the read error. Therefore if the cause of the read error is a media defect of the magnetic disk, the read error cannot be improved even if the flying height is adjusted to the limit of the adjustment range, and execution of unnecessary adjustment when the magnetic disk is operating causes a drop in performance.

When the flying height of a magnetic head is decreased to the limit of the adjustment range, the magnetic head can easily cause unrecoverable failure if another factor (e.g. temperature and air pressure fluctuation and deposit of lubricant) is generated. In other words, the magnetic head and magnetic disk tend to collide, and damage to the magnetic head and magnetic disk more easily occurs.

### SUMMARY

With the foregoing in view, it is an object of the present invention to provide a head flying height control device and a magnetic disk device for changing heater power and controlling the flying height when the flying height control is effective depending on the cause of the read error.

To achieve this object, a magnetic disk device has: a magnetic head which floats by the rotation of a magnetic disk, and has at least a read element, a write element and a heater element; and an actuator which moves the magnetic head in a radius direction of the magnetic disk; and a control circuit which executes a correction processing of heater power to be provided to the heater element and adjusts a flying height of the magnetic head, wherein the control circuit checks read performance, detects a drop in read performance, judges whether a cause of the drop in read performance is in the magnetic head or the magnetic disk, and executes the correction processing of the heater power when judgment is made that the cause of the drop in read performance is in the magnetic head.

To achieve the object, a flying height control device for a magnetic head is a flying height control device for a magnetic head that moves a magnetic head, which floats by rotation of a magnetic disk and has at least a read element and a write element, in a radius direction of the magnetic disk by an actuator, having: a table for storing a read performance by a read operation of the magnetic head; and a control circuit which executes a correction processing of heater power to be provided to the heater element and adjusts a flying height of the magnetic head, wherein the control circuit checks the read performance referring to a table, detects a drop in read performance, judges whether a cause of the drop in read performance is in the magnetic head or the magnetic disk, and executes the correction processing of the heater power when judgment is made that the cause of the drop in read performance is in the magnetic head.

When the read performance is checked and the drop in read performance is detected, the control circuit judges and discerns whether the cause of the drop in read performance is in the magnetic head or the magnetic disk, and executes the flying height control by the heater power correction processing if it is judged that the cause of the drop in read performance is in the magnetic head, therefore unnecessary adjustment while the magnetic disk device is operating is prevented, and the probability of collision between the magnetic head and the magnetic disk, due to the control to lower the flying height of the magnetic head, can be decreased when the magnetic disk is the cause of the problem.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a front view depicting a magnetic disk device according to an embodiment of the present invention;

FIG. 2 is a diagram depicting configurations of the magnetic head and magnetic disk in FIG. 1;

FIG. 3 is a circuit block diagram of the magnetic disk device in FIG. 1;

FIG. 4 is a diagram depicting a track format of the magnetic disk in FIG. 1;

FIG. 5 is a diagram depicting a track format of another surface of the magnetic disk in FIG. 1;

FIG. 6 is a diagram depicting an embodiment of a self monitoring, analysis and reporting (SMART) command of the present invention;

FIG. 7 explains the SMART attributes ID of FIG. 6;

FIG. 8 explains a read error rate guaranteed failure threshold of the SMART attributes in FIG. 7;

FIG. 9 explains system information of the magnetic disk device in FIG. 1 to FIG. 5;

FIG. 10 explains DHF heater power setting tables in FIG. 9;

FIG. 11 shows the back-off correction value setting table in FIG. 9;

FIG. 12 is a graph explaining a touchdown profile of the head to create the table in FIG. 11;

FIG. 13 is a table explaining the heater power sensitivity calculated from the profile in FIG. 12;

FIG. 14 explains the read error log table in FIG. 9;

FIG. 15 is a flow chart (Part 1) of the flying height control processing according to an embodiment of the present invention; and

FIG. 16 is a flow chart (Part 2) of the flying height control processing according to an embodiment of the present invention.

### DESCRIPTION OF EMBODIMENTS

Embodiments of the present invention will now be described in the sequence of a magnetic disk device, self monitoring, analysis and reporting functions, DFH table, flying height control of magnetic head, and other embodiments, but the present invention is not limited to these embodiments.

(Magnetic Disk Device)

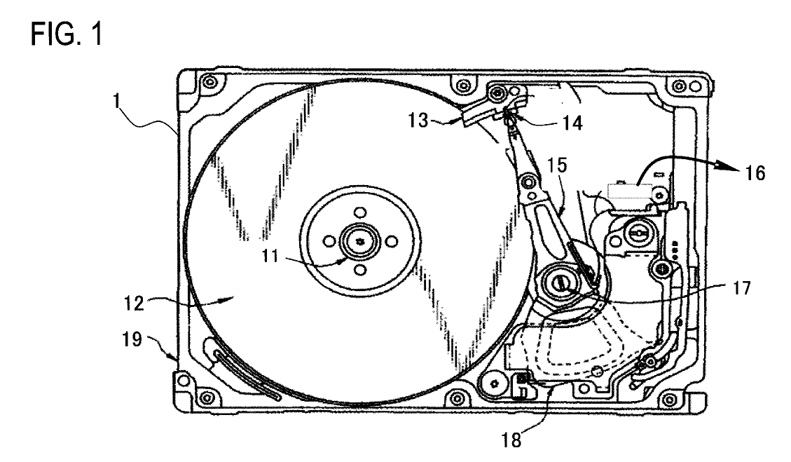

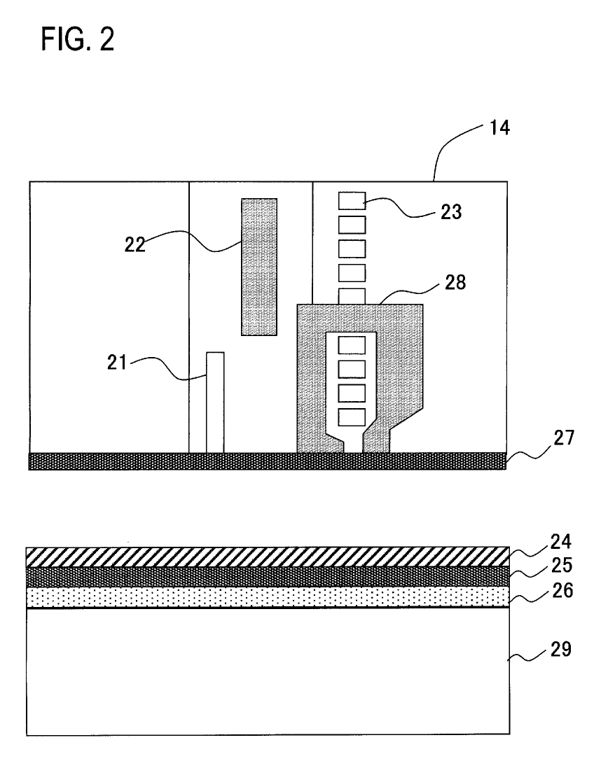

FIG. 1 is an external view depicting an embodiment of a magnetic disk device of the present invention. FIG. 2 is a cross-sectional view of the magnetic head in FIG. 1. As FIG. 1 shows, the magnetic disk device 19 has a magnetic disk 12, a magnetic head 14 including a head slider, a head suspension assembly 15 which supports the magnetic head 14, a voice coil motor (VCM) 18, and a circuit board, which are housed in a disk enclosure 1.

In addition to a head IC, a temperature/humidity sensor 16 is installed on the circuit board. For the temperature sensor, a thermocouple, thermistor, IC temperature sensor or band gap base temperature sensor, for example, can be used. For the humidity sensor, a resistance type or capacitance type polymer humidity sensor, for example, can be used.

The magnetic disk 12 is installed on a spindle motor 11, and rotates. The head suspension assembly 15 is installed on a pivot 17, and positions the magnetic head 14 to an arbitrary radius position of the magnetic disk 12 by the voice coil motor (VCM) 18.

A ramp load mechanism 13 is a mechanism for parking the magnetic head 14 retracted from the magnetic disk 12. The magnetic disk device of the present embodiment has a ramp load mechanism 13, but the present invention can also be applied to a contact start and stop type magnetic disk device of which magnetic head 14 stands by in a predetermined area of the magnetic disk 12 when the device is stopping.

FIG. 2 is a cross-sectional view depicting the magnetic head 14 in FIG. 1, viewed from the circumferential direction of the magnetic disk 12. In the magnetic head 14, a recording element having a recording coil 23 and a recording core 28, a reproducing element 21 and a heater (heater element) 22 are installed. For the reproducing element 21, a GMR (Giant Magneto Resistance) element or TMR (Tunneling Magneto Resistance) element is used.

A diamond like carbon (DLC) protective film 27 is formed on the surface of the magnetic head 14. Since the surface energy of the diamond like carbon (DLC) protective film 27 is high, lubrication film, moisture and other contaminants easily adhere to the film. In the case of the present embodiment, low surface energy treatment is performed on the surface of the magnetic head 14. The low surface energy treatment can be implemented by injecting fluorine ions or coating with fluoro-resin.

In the magnetic disk 12, on the other hand, a magnetic film 26 (including the SUL layer in the case of a vertical recording disk), and a diamond like carbon (DLC) protective film 25 are formed on a substrate 29 in this sequence, and a lubrication film 24 is formed thereon as an outermost surface.

In this lubrication film 24, the amount of components absorbed by the underlayer film, that is, the diamond like carbon (DLC) protective film 25, changes depending on the coating conditions and the processing conditions. For example, the absorption components increase by performing heat processing and UV irradiation processing.

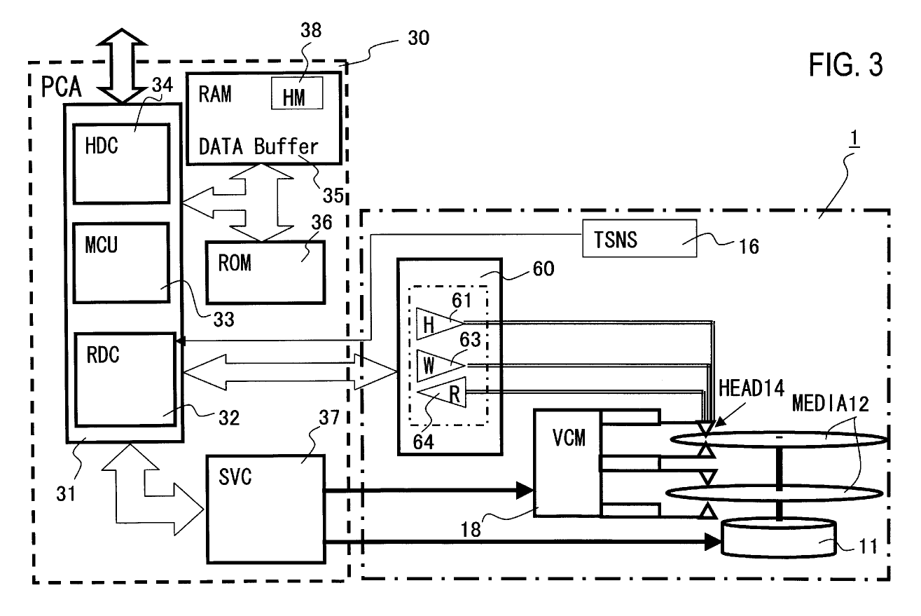

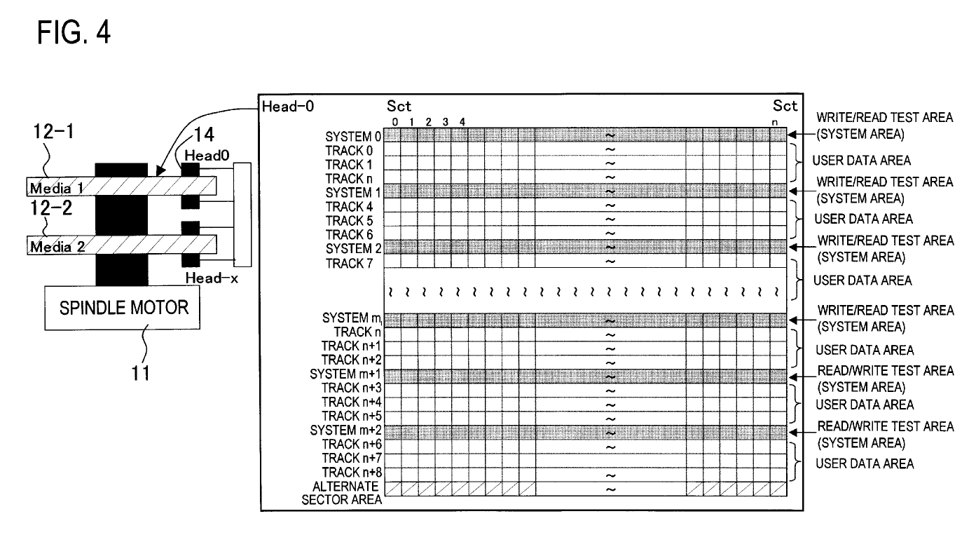

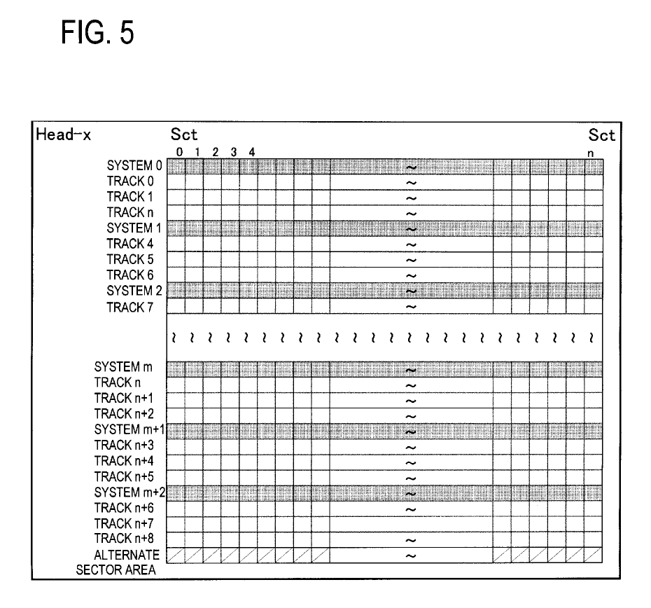

FIG. 3 is a circuit block diagram of an embodiment of the magnetic disk device of the present invention, FIG. 4 and FIG. 5 are diagrams depicting the configuration of the track layout of the magnetic disk in FIG. 3. In FIG. 3, composing elements the same as FIG. 1 and FIG. 2 are denoted with the same symbols.

As FIG. 3 shows, a preamplifier (head IC) 60 is installed near the VCM 18 of the disk enclosure (DE) 1 described in FIG. 1. In DE 1, a temperature/humidity sensor 16, for detecting temperature and humidity in the DE 1, is also installed.

In the print circuit assembly (control circuit unit) 30, a hard disk controller (HDC) 34, microcontroller (MCU) 33, read/write channel circuit (RDC) 32, servo control circuit 37, data buffer (RAM) 35, and ROM (Read Only Memory) 36 are installed. In this embodiment, the HDC 34, MCU 33 and RDC 32 are integrated on one LSI 31.

The read/write channel circuit (RDC) 32 is connected to the preamplifier 60, and controls the magnetic head 14 to read and write data. In other words, the RDC 32 performs signal shaping, data modulation and data demodulation. The servo control circuit (SVC) 37 controls the driving of the spindle motor 11, and also controls the driving of the VCM 18.

The hard disk controller (HDC) 34 mainly performs interface protocol control, data buffer control and disk format control. The data buffer (RAM) 35 temporarily stores read data and write data.

The data buffer 35 stores the later mentioned flying height control values 38. The flying height control values 38 are stored in a system area of the magnetic disk 12, and are read from the system area of the magnetic disk 12 when the device is started, and are stored in the data buffer (RAM) 35.

The microcontroller (MCU) 33 controls the HDC 34, RDC 32 and SVC 37, and manages the RAM 35 and ROM 36. The ROM 36 stores various programs and parameters.

The preamplifier 60 in FIG. 2 has a read amplifier 64 which amplifies read signals from the read element 21 (see FIG. 2), and outputs them to the read channel circuit 32, a write amplifier 63 which amplifies write signals from the read channel circuit 32, and supplies them to a write coil 23, a heater driving circuit 61, which receives the predetermined power from the read channel circuit 32 and drives the heater element 22 of the magnetic head 14, and a heater control circuit (not illustrated), which controls the heater driving circuit 61.

The track format configuration of the magnetic disk 12 in FIG. 3 will now be described with reference to FIG. 4 and FIG. 5. In FIG. 4, four magnetic heads 14, which reads/writes each surface of the magnetic disks 12-1 and 12-2, are installed for the two magnetic disks 12-1 and 12-2.

FIG. 4 shows a track format configuration on the magnetic disk surface of the first magnetic head 14 (Head-0). In the example shown here, a number of sectors per round in the circumferential direction of the magnetic disk 12-1 is n+1 (sector 0 to n). The magnetic disk 12-1 is divided into plural zones 0 to m+2 in the radius direction. Each zone 0 to m+2 consists of a system area (tracks for system area) 0 to m+2, and a user data area comprised of plural tracks. An alternate sector area is also created.

FIG. 5 shows a track format configuration on the magnetic disk surface of the fourth magnetic head 14 (Head-0). In this example, just like FIG. 4, a number of sectors per round in the circumferential direction of the magnetic disk 12-1 is n+1 (sectors 0 to n). The magnetic disk 12-1 is divided into many zones 0 to m+2 in the radius direction. Each zone 0 to m+2 consists of a system area (tracks for system area) 0 to m+2, and user data area comprised of many tracks. An alternate sector area is also created.

In the system area, system information including a DFH (Dynamic Flying Height) heater power table is stored, as mentioned later. Using the system area, the cause of a deterioration in the read error rate (whether the defect is in the head or disk media) is discerned, and a write/read test is performed to confirm improvement after heater power correction.

(Self Monitoring, Analysis and Reporting Function)

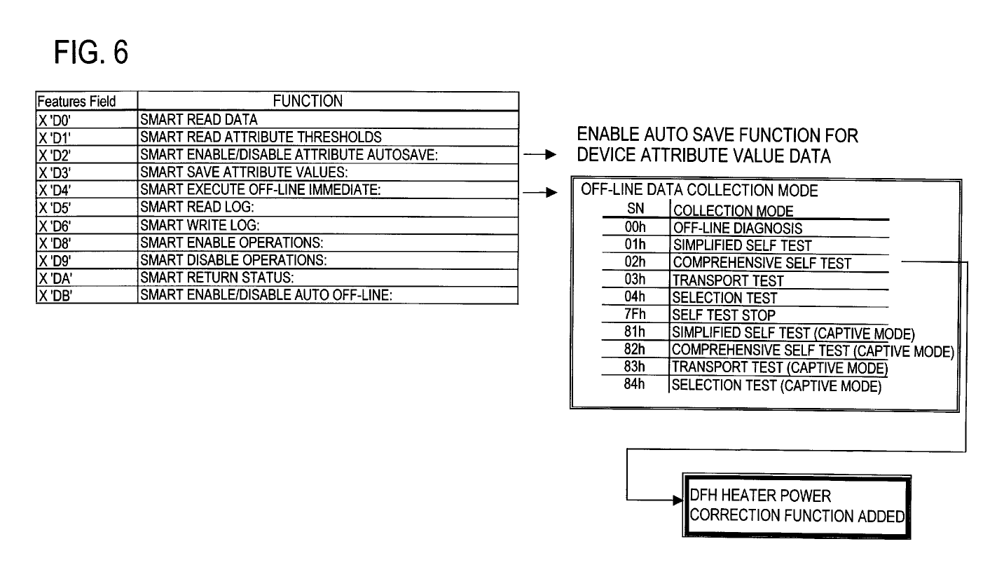

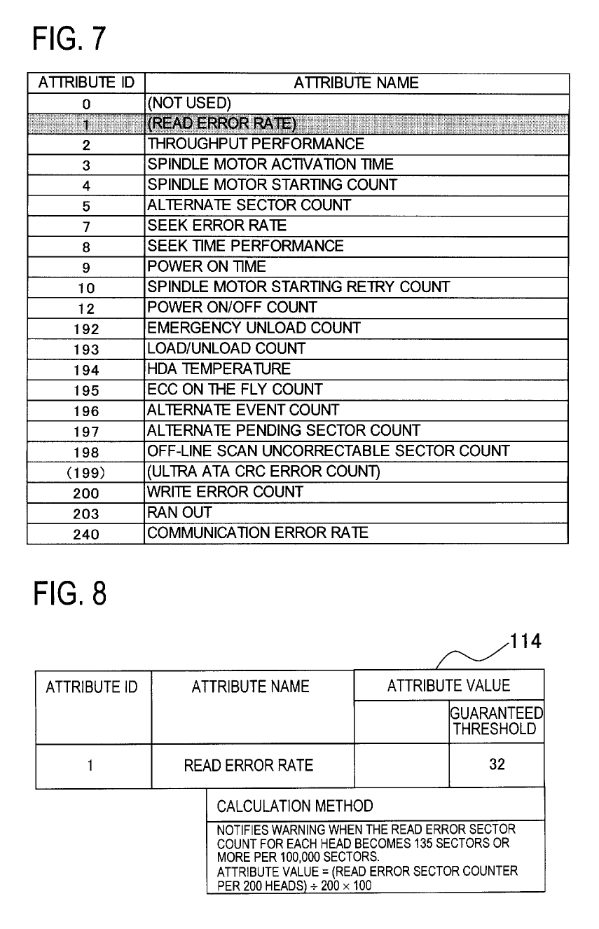

FIG. 6 is a diagram depicting an embodiment of a self monitoring, analysis and reporting (SMART) command, FIG. 7 explains the SMART attribute IDs in FIG. 6, and FIG. 8 explains the read error rate guaranteed failure threshold of the SMART attributes in FIG. 7.

The self monitoring, analysis and reporting function will be described using the SMART function. SMART (Self Monitoring, Analysis and Reporting Technology) is installed in a magnetic disk device for the early discovery of problems and prediction of failures. With SMART, various characteristics and performances are self-diagnosed in real-time, and the diagnosed state is expressed by numerical values. Since the host can know the numerical values, SMART is an effective technology to know a failure due to age related deterioration in a stable operating environment.

FIG. 6 shows the sub-commands of SMART which a magnetic disk device normally supports, where 11 types of sub-commands specified by a value (e.g. X‘D0’) of the future field register, and the functions thereof are shown. For example, the sub-command X‘D2’ is a function to enable the auto save function of the SMART attribute value data. The sub-command X‘D4’ specifies the off-line data collection mode. The sub-command X‘DA’ specifies the state return (report).

In the off-line data collection mode specified by the sub-command X‘D4’, the type of the collection mode can also be specified. For example, when the mode register value SN=02h is set, a comprehensive self test on read and write is specified. In the same manner, when the mode register value SN=01h is set, a simplified self test on read only is specified.

These commands are set as a sub-command and mode specification in a command block of which a command type is specified to SMART, and is notified to the host. In the present embodiment, correction of the DFH heater power requires read and write, as shown in FIG. 6, so the DFH heater power correction function is added to the comprehensive self test mode.

In order to correct the DFH heater power using this SMART function, conventional SMART attributes are used. As FIG. 7 shows, the SMART attributes to be collected in the device using the SMART functions are the read error rate, throughput performance, spindle motor starting time, spindle motor starting count, alternate sector count, seek error rate and other.

For the attribute value of each attribute, a guaranteed fault threshold is created, and a warning is notified to the host if the attribute value of the attribute exceeds the threshold, that is, the analysis and reporting functions are provided. FIG. 8 shows the guaranteed failure threshold values of the read error rate, and how to calculate the attribute values.

In this example, the guaranteed fault threshold of the read error rate is set to “32”. This threshold is a threshold to notify a warning when the read error sector count becomes 135 or more per 100,000 sectors for each head. For this, this attribute value of the read error rate is calculated by the following Expression (1).

Attribute value=((200−(read error sector count per head))±200)+100 (1)

If the read error sector count per heat is “135”, for example, the attribute value is ((200−135)/200)+100=32.5 according to Expression (1). Since this exceeds the guaranteed threshold (=32) in the comparison with the guaranteed threshold, a warning is notified.

(DFH Table)

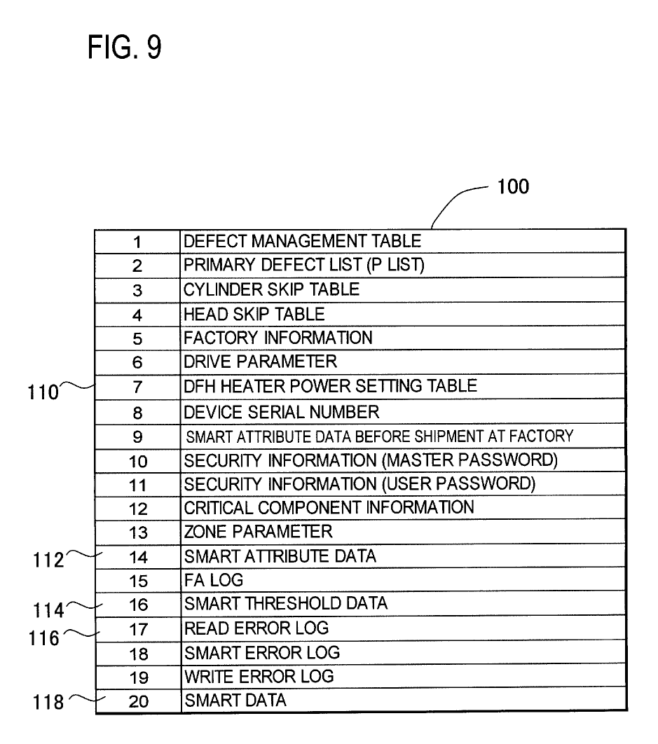

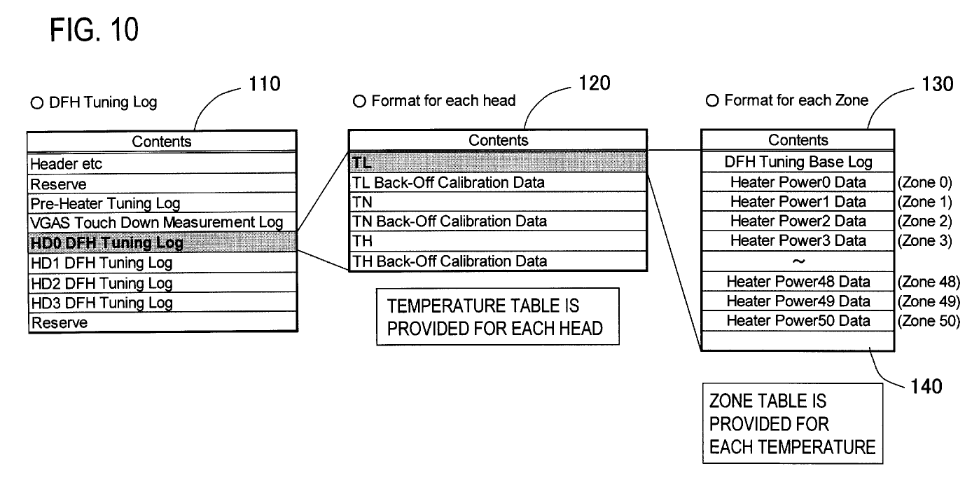

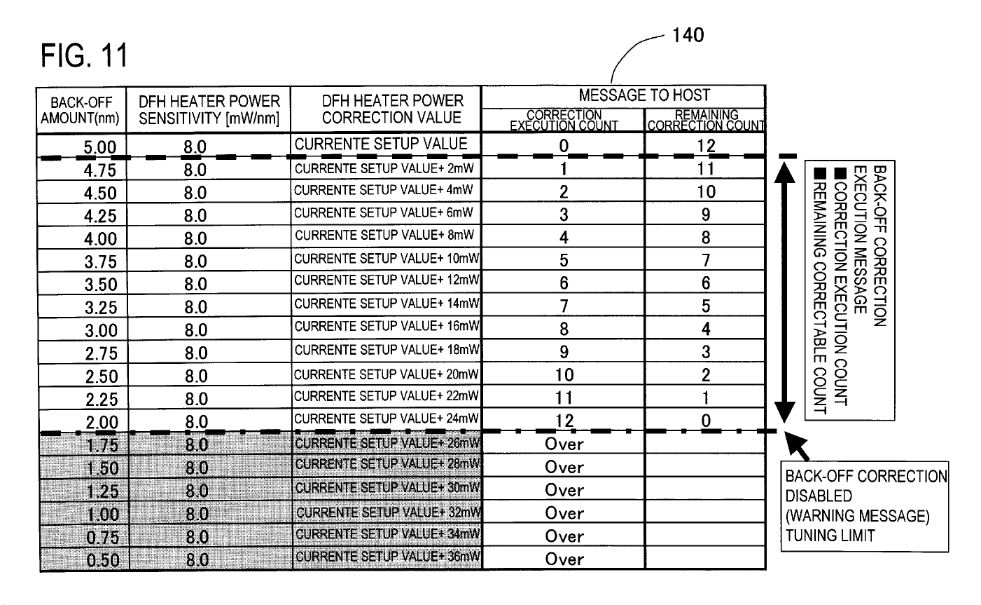

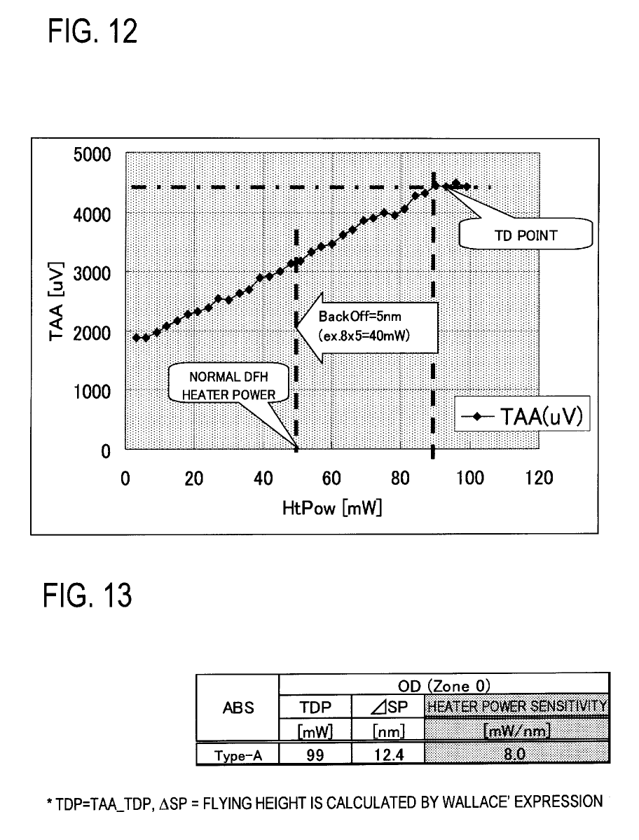

Then a setting table to correct DFH heater power is created as the system information. FIG. 9 explains the system information of the magnetic disk device shown in FIG. 1 to FIG. 5, FIG. 10 explains the DFH heater power setting table in FIG. 9, FIG. 11 explains the back-off correction value setup table in FIG. 9, FIG. 12 is a graph explaining the touchdown profile of the head for creating the table in FIG. 11, and FIG. 13 explains the heater power sensitivity calculated from the profile in FIG. 12.

As FIG. 9 shows, the system information 100 is comprised of a defect management table, primary defect list, cylinder skip table, head skip table, drive parameters and other. Here the system information on the DFH heater power correction will be described.

The DFH heater power setting table 110, to be described in FIG. 10 and later, is created as the system information 100. For the system information 100, a SMART attribute data 112 for storing the collected SMART items (e.g. read error sector count) explained in FIG. 7, a SMART threshold table 114 for storing the read error insured threshold explained in FIG. 8, a read error log 116 for logging the read errors, and a SMART data 118 for storing initial error rates obtained during test and adjustment, are used.

This system information 100 is stored in the system area of the magnetic disk 12 described in FIG. 4 and FIG. 5, and is read to the data buffer 35 in FIG. 3 at power ON.

As FIG. 10 shows, the DFH heater power setting table 110 stores the DFH adjustment table 120 of each head HD0 to HD3. The DFH adjustment table 120 stores a table 130 storing the heat power of each zone of each temperature, that is, the low temperature (TL), normal temperature (TN) and high temperature (TH), and the back-off calibration data of each temperature.

The heat power table 130 stores the heat power value of each zone (zones 0 to 50 in this case) of the magnetic disk 12. The heat power table 130 also stores the back-off correction value setting table 140 in FIG. 11.

As FIG. 11 shows, the back-off correction value setting table 140 stores a DFH power heater sensitivity (mW/nm), a DFH power heater correction value, a correction execution count and a remaining correction count, with respect to each back-off amount (height from contact point: nm).

In this example, the correction execution count and remaining correctable count are notified as the back-off correction execution message every time DFH heater power correction is performed until the correction count reaches 12 times. If the correction count exceeds 12 times, the back-off correction disabled message (warning message) is reported. The heater power is corrected by adding 2 mW to the current setup value every time correction is performed. In this example, when 24 mW is added and the back-off amount is 1.75 nm, back-off correction disabled is reported to the host as the tuning limit.

As FIG. 12 shows, this table 140 is created from the data obtained in the touchdown test steps of the magnetic head of the magnetic disk device. In other words, in FIG. 12, the profile of the head output TAA (μA) of the magnetic head is created while adding the heater power HtPow (mW), and the heater power when the head output is saturated is determined as the touchdown (TD) point.

Then, as FIG. 13 shows, the flying height change ΔSP is calculated from the initial reproducing amplitude (TAA) V1 of the head when the heater power is not applied, the reproducing amplitude (TAA) V2 at the touchdown point, and the wavelength λ of the recording pattern, using known Wallace' Expression (2), as shown below.

Flying height change ΔSP=λ/(2π)×LN (V2/V1)− (2)

where LN is logarithm Loge.

Then the heater power value TDP at the touchdown point (99 mW in this case) is divided by the above mentioned flying height change ΔSP (12.4 nm in this case) to calculate the heater power sensitivity (mW/nm). Here the heater power sensitivity is 99/12.4=8. When the back-off amount is set to 5 nm, the heater power value to obtain a 5 nm flying height is calculated (8+5=40 mW in this case), and the above mentioned setup value is acquired.

The values in FIG. 12 and the heat power setup values are stored as the heat power data of each zone in the heat power table 130 in FIG. 10. Based on the test result in FIG. 12 and FIG. 13, the back-off correction value table in FIG. 11 is created.

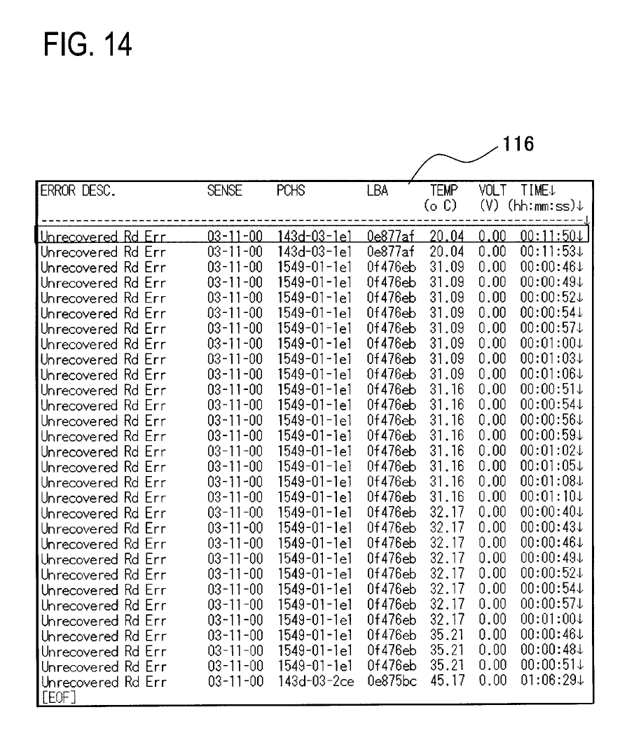

FIG. 14 explains the read error log 17. The read error log 17 (see FIG. 9) consists of an error content (Error DESC) of each error log, error code (SENSE), error physical address (PCHS: cylinder, head, sector), logical address (LBA), error temperature (TEMP), error voltage (VOLT), and error detection time (TIME).

Using this DFH table, the flying height control to be described below is performed.

(Flying Height Control of Magnetic Head)

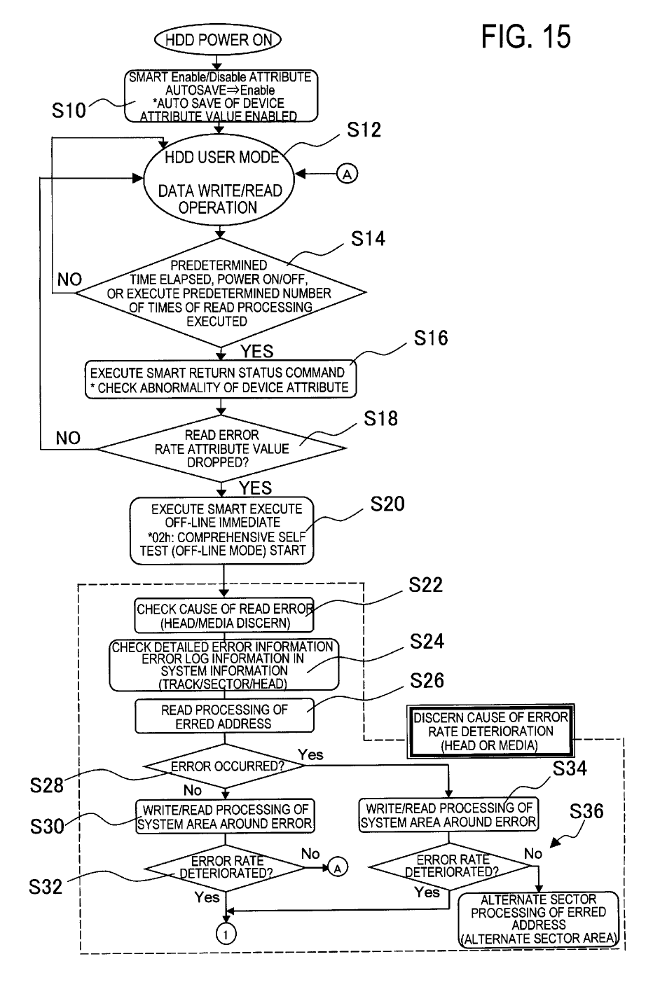

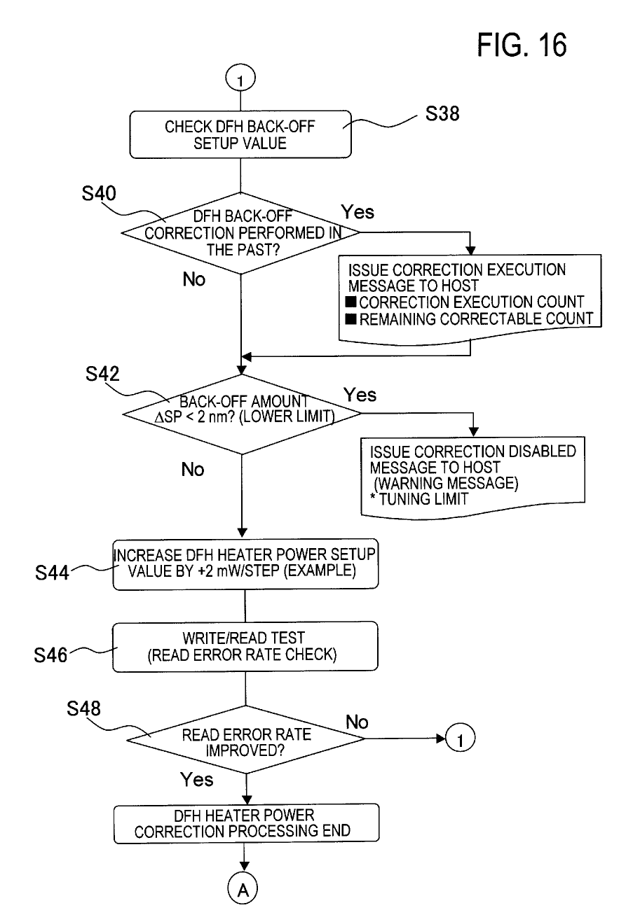

FIG. 15 and FIG. 16 are flow charts depicting a flying height control processing using the SMART function according to an embodiment of the present invention. The processings in FIG. 15 and FIG. 16 are performed by the MCU 33 in FIG. 3, executing the adjustment program stored in RAM 35 or ROM 36.

(S10) After power is turned ON, the MCU 33 receives a SMART command (SMART ENABLE/DISABLE ATTRIBUTE AUTO SAVE sub-command), and enables the auto save function for device attribute values.

(S12) In user mode, the MCU 33 performs normal read/write operation to/from the magnetic head. At this time, the MCU 33 logs the read/write state in the system information using the auto save function.

(S14) When a predetermined operation time elapses, or when power ON/OFF is generated in this user mode, the MCU 33 judges whether read processing was executed for a predetermined number of times. When the predetermined operation time has not yet elapsed, or when power ON/OFF is not generated in the user mode, or the read processing has not been executed for a predetermined number of times, the MCU 33 returns to step S12.

(S16) When the predetermined time has elapsed, or when power ON/OFF is generated in this user mode, or read processing is executed for a predetermined number of times, the MCU 33 notifies this state to the host, receives the SMART RETURN STATUS command from the host, and checks the device attribute values of SMART (FIG. 7). In other words, the MCU 33 checks the SMART attribute data (device attribute values) in FIG. 9 and the thresholds, and monitors for abnormalities. Then the presence of an abnormality and device attribute value are reported to the host.

(S18) At this time, the MCU 33 compares the read error rate attribute value described in FIG. 9 and the threshold, and judges whether the read error rate is abnormal, and if the read error rate is abnormal, the MCU 33 waits for the SMART EXECUTE OFF-LINE IMMEDIATE command from the host.

(S20) When the SMART EXECUTE OFF-LINE IMMEDIATE command is received from the host, the MCU 33 starts the comprehensive self test (off-line mode), as described in FIG. 6.

(S22) By this command, the MCU 33 performs the read/write performance test on a off-line state. First MCU 33 starts processing that the cause of the error rate deterioration discern.

(S24) The MCU 33 specifies the track/sector/head in which errors frequently occur based on the error log information 116 (see FIG. 14) in the system information 100.

(S26) The MCU 33 performs read processing of the specified address. In other words, the HDC 34 issues the read command to read this address. By this, the read channel 32 reads the data in this address via the magnetic head 14 and the head IC 60, demodulates the data, corrects the error, and judges whether read succeeded.

(S28) The MCU 33 receives the instructed read processing result, and judges whether an error occurred.

(S30) If it is judged that an error did not occur, the MCU 33 performs write/read processing for the system area around this address. For example, in the case of FIG. 4, if a sector with the specified address exists in the track of zone 0, write/read processing is performed using the system area in zone 0. In this case, system information is stored in the system area, so a test area (sector) is assigned to an area other than the area where system information is stored, and data is written and read in the test area in the system area. This data write/read is repeated many times (e.g. 100 times), and the error rate is measured.

(S32) The MCU 33 compares this measured error rate and the initial error rate stored in the SMART data 118 of the system area 100 in FIG. 9, and judges whether the error rate deteriorated. If the error rate did not deteriorate, this means that an error was not detected in step S30, that is, the media is not defective and adjustment of the magnetic head is unnecessary, therefore the MCU 33 returns to step S12.

(S34) If it is judged that an error occurred, the MCU 33 judges it as a defect of the magnetic disk or deterioration of the magnetic head. Then the MCU 33 performs the write/read processing in the system area around the address, just like step S30. For example, data is written and read in the test area of the system area in the zone. This data write/read is repeated many times (e.g. 100 times), and the error rate is measured.

(S36) The MCU 33 compares this measured error rate and the initial error rate stored in the SMART data 118 of the system area 100 in FIG. 9, and judges whether the error rate deteriorated. If the error rate did not deteriorate, this means that an error was detected in step S30, that is, not the head but the media is defective, therefore MCU 33 sets an alternate sector, and processes the alternate sector.

(S38) Referring to FIG. 16 again, if it is judged that the error rate deteriorated in step S32 and S36, the MCU 33 judges that adjustment of the magnetic head is necessary, and starts DFH heater correction processing. First the MCU 33 checks the DFH back-off setup value (heater power correction value) from the back-off correction value setting table 140 in FIG. 11.

(S40) The MCU 33 judges whether back-off correction was executed in past based on the back-off correction value setting table 140 in FIG. 11. When the back-off correction was executed, the MCU 33 reports with the correction execution message including the correction execution count and the remaining correctable count, described in FIG. 11, to the host as a response.

(S42) The MCU 33 judges whether the current back-off amount ΔSP exceeds 2 nm (lower limit) based on the back-off correction value setting table 140 in FIG. 11. If it is judged that the current back-off amount ΔSP exceeds 2 nm (lower limit), the MCU 33 reports with the correction disabled message (warning message) described in FIG. 11 to the host as a response. And processing ends without adjustment.

(S44) If it is judged that the current back-off amount ΔSP does not exceed 2 nm (lower limit), the MCU 33 increases the DFH heater power setup value. In other words, as described in FIG. 11, the MCU 33 changes the setup value by adding +2 mW, and drives the heater 22 with this updated heater power setup value.

(S46) Just like the above mentioned step S30, the MCU 33 performs write/read processing in a system area around this address. For example, data is written and read in the test area of the system area. This data write and read are repeated many times (e.g. 100 times), and the error rate is measured.

(S48) The MCU 33 compares this measured error rate and the initial error rate stored in the SMART data 118 in the system area 100 in FIG. 9, and judges whether the error rate improved. If the error rate improved, the MCU 33 ends the DFH heater power correction processing. If the error rate was not improved, the MCU 33 returns to step S38, and performs processing to increase the heater power.

When the read performance (error rate) is checked and the drop in read performance is detected, the control circuit judges and discerns whether the cause of the drop in read performance is in the magnetic head or the magnetic disk, and executes the flying height control by the heater power correction processing if it is judged that the cause of the drop in read performance is in the magnetic head. Therefore unnecessary adjustment while the magnetic disk device is operating is prevented, and the probability of collision between the magnetic head and the magnetic disk, due to the control to lower the flying height of the magnetic head, can be decreased when the magnetic disk is the cause of the problem.

Also according to the present embodiment, self discovery of read performance is performed by correcting heater power, utilizing the self monitoring, analysis and reporting functions of a magnetic disk device which has the self monitoring, analysis and reporting functions, such as SMART, and the host can sequentially receive reports utilizing these functions, and can shift to processing bypassing data loss before actual data loss occurs. Since the data of the self monitoring, analysis and reporting functions is used, the present invention can be implemented simply by adding the DFH heater power correction function, which can be easily installed.

The present embodiment can be summarized as follows.

(1) The magnetic disk device has: a magnetic head which floats by the rotation of a magnetic disk and has at least a read element, a write element and a heater 10 element; an actuator which moves the magnetic head in a radius direction of the magnetic disk; and a control circuit which executes a correction processing of heater power to be provided to the heater element so as to adjust a flying height of the magnetic head, where the control circuit checks read performance, judges whether the cause of the drop in read performance is in the magnetic head or the magnetic disk if the drop in read performance is detected, and executes the correction processing of the heater power if it is judged that the cause of the drop in read performance is in the magnetic head.

(2) When the drop in read performance is detected, the control circuit positions the magnetic head in a test area, which is an area other than a user area, on the magnetic disk, writes test data in the test area by the magnetic head, reads the written test data, measures a read error rate, and judges whether the cause of the drop in read performance is in the magnetic head or the magnetic disk.

(3) The control circuit executes an alternating area processing of an area where the read performance dropped when the cause of the drop in read performance is in the magnetic disk.

(4) The control circuit judges whether the measured read error rate is lower than a predetermined read error rate, and judges that the cause of the drop in read performance is in the magnetic head if it is lower, and judges that the cause of the drop in read performance is in the magnetic disk if it is not lower.

(5) The control circuit accumulates each read error rate acquired in the read operation of the magnetic head, and checks the read performance.

(6) The control circuit detects the drop in read performance by comparing the accumulated read error rate and the predetermined read error rate.

(7) The control circuit logs details of the read error, and when the drop in read performance is detected, the control circuit discerns an address corresponding to the error of the magnetic disk referring to the log, executes read processing in the address corresponding to the error by the magnetic head to judges whether a read error is detected, judges whether the measured read error rate is lower than the predetermined read error rate, and determines that the cause of the drop in read performance is in the magnetic head if the read error rate is lower than the predetermined read error rate, and determines that the cause of the drop in read performance is in the magnetic disk if the read error is detected and the read error rate is not lower than the predetermined read error rate.

(8) If the read error is not detected and if the read error rate is not lower than the predetermined read error rate, the control circuit judges that the cause of the drop in read performance is neither in the magnetic head nor in the magnetic disk.

(9) The control circuit increases the heater power to be provided to the heater element to decrease the flying height of the magnetic head, then measures a read error rate by writing data on the magnetic disk and reading it by the magnetic head, and checks whether the read error rate has improved or not.

(10) The control circuit increases the heater power when it is judged that the read error rate has not improved.

### Other Embodiments

The above embodiment discerns and judges the case of error using the SMART functions, but can also be applied to devices which do not have these functions. A report to the host is not always necessary. The present invention was described using a magnetic disk device in which two magnetic disks are installed, but can also be applied to a device in which one magnetic disk, or three or more magnetic disks are installed.

The configuration of the magnetic head is not limited to one in FIG. 2, but the present invention can also be applied to another configuration of a separate type magnetic head. The heater drive circuit may be installed not in the head IC, but at the control circuit side.

When the read performance is checked and the drop in read performance is detected, the control circuit judges and discerns whether the cause of the drop in read performance is in the magnetic head or the magnetic disk, and executes the flying height control by the heater power correction processing if it is judged that the cause of the drop in read performance is in the magnetic head, therefore unnecessary adjustment while the magnetic disk device is operating is prevented, and the probability of collision between the magnetic head and the magnetic disk, due to the control to lower the flying height of the magnetic head, can be decreased when the magnetic disk is the cause of the problem.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has been described in detail, it should be understood that the various changes, substitutions, and alterations could be made hereto without departing from the spirit and scope of the invention.

1. A magnetic disk device, comprising:
a magnetic head which floats by rotation of a magnetic disk, and has at least a read element, a write element and a heater element;
an actuator which moves the magnetic head in a radius direction of the magnetic disk; and
a control circuit which executes a correction processing of heater power to be provided to the heater element and adjusts a flying height of the magnetic head, wherein
the control circuit checks read performance, detects a drop in read performance, judges which a cause of the drop in read performance is in the magnetic head and the magnetic disk, and executes the correction processing of the heater power when judging that the cause of the drop in read performance is in the magnetic head.

2. The magnetic disk device according to claim 1, wherein the control circuit detects the drop in read performance, positions the magnetic head in a test area, which is an area other than a user area, on the magnetic disk, writes test data in the test area by the magnetic head, reads the written test data, measures a read error rate, and judges which the cause in the drop in read performance is in the magnetic head and the magnetic disk.

3. The magnetic disk device according to claim 1, wherein the control circuit executes an alternating area processing of an area where the read performance has dropped when judging that the cause of the drop in read performance is in the magnetic disk.

4. The magnetic disk device according to claim 2, wherein the control circuit judges whether the measured read error rate is lower than a predetermined read error rate, and judges that the cause of the drop in read performance is in the magnetic head when the rate is lower, and judges that the cause of the drop in read performance is in the magnetic disk when the rate is not lower.

5. The magnetic disk device according to claim 1, wherein the control circuit accumulates each read error rate acquired in read operation of the magnetic head, and checks the read performance.

6. The magnetic disk device according to claim 5, wherein the control circuit detects the drop in read performance by comparing the accumulated read error rate and the predetermined read error rate.

7. The magnetic disk device according to claim 4, wherein
the control circuit logs details of the read error, discerns an address corresponding to the error of the magnetic disk in reference to the log when detecting the drop in read performance, executes read processing in the address corresponding to the error by the magnetic head to determine whether a read error is detected, judges whether the measured read error rate is lower than the predetermined read error rate, and judges that the cause of the drop in read performance is in the magnetic head when the read error rate is lower than the predetermined read error rate, and judges that the cause of the drop in read performance is in the magnetic disk when the read error is detected and the read error rate is not lower than the predetermined read error rate.

8. The magnetic disk device according to claim 7, wherein
when the read error is not detected and when the read error rate is not lower than the predetermined read error rate, the control circuit judges that the cause of the drop in read performance is neither in the magnetic head nor in the magnetic disk.

9. The magnetic disk device according to claim 1, wherein
the control circuit increases the heater power to be provided to the heater element to decrease the flying height of the magnetic head, then measures a read error rate by writing data on the magnetic disk and reading the same by the magnetic head, and checks whether the read error rate has improved or not.

10. The magnetic disk device according to claim 9, wherein the control circuit increases the heater power when judgment is made that the read error rate has not improved.

11. A flying height control device for a magnetic head that moves a magnetic head, which floats by rotation of a magnetic disk and has at least a read element and a write element, in a radius direction of the magnetic disk by an actuator, comprising:
a table for storing a read performance by a read operation of the magnetic head; and
a control circuit which executes a correction processing of heater power to be provided to the heater element and adjusts a flying height of the magnetic head, wherein
the control circuit checks the read performance referring to the table, detects a drop in read performance, judges which the cause of the drop in read performance is in the magnetic head and the magnetic disk, and executes correction processing of the heater power when judging that the cause of the drop in read performance is in the magnetic head.

12. The flying height control device for a magnetic head according to claim 11, wherein
the control circuit detects the drop in the read performance, positions the magnetic head in a test area, which is an area other than a user area, on the magnetic disk, writes test data in the test area by the magnetic head, reads the written test data, measures a read error rate, and judges whether the cause in the drop in read performance is in the magnetic head or the magnetic disk.

13. The flying height control device for a magnetic head according to claim 11, wherein the control circuit executes an alternating area processing of an area where the read performance has dropped when judging that the cause of the drop in read performance is in the magnetic disk.

14. The flying height control device for a magnetic head according to claim 12, wherein the control circuit judges whether the measured read error rate is lower than a predetermined read error rate, and judges that the cause of the drop in read performance is in the magnetic head when the rate is lower, and judges that the cause of the drop in read performance is in the magnetic disk when the rate is not lower.

15. The flying height control device for a magnetic head according to claim 11, wherein
the control circuit accumulates each read error rate acquired in read operation of the magnetic head, and checks the read performance.

16. The flying height control device for a magnetic head according to claim 15, wherein the control circuit detects the drop in read performance by comparing the accumulated read error rate and the predetermined read error rate.

17. The flying height control device for a magnetic head according to claim 14, wherein
the control circuit logs details of the read error, discerns an address corresponding to the error of 10 the magnetic disk in reference to the log when detecting the drop in read performance, executes read processing in the address corresponding to the error by the magnetic head to judge whether a read error is detected, judges whether the measured read error rate is lower than the predetermined read error rate, and judges that the cause of the drop in read performance is in the magnetic head when the read error rate is lower than the predetermined read error rate, and judges that the cause of the drop in read performance is in the magnetic disk when the read error is detected and the read error rate is not lower than the predetermined read error rate.

18. The flying height control device for a magnetic head according to claim 17, wherein when the read error is not detected and when the read error rate is not lower than the predetermined read error rate, the control circuit judges that the cause of the drop in read 10 performance is neither in the magnetic head nor in the magnetic disk.

19. The flying height control device for a magnetic head according to claim 11, wherein the control circuit increases the heater power to be provided to the heater element to decrease the flying height of the magnetic head, then measures a read error rate by writing data on the magnetic disk and reading the same by the magnetic head, and checks whether the read error rate has improved or not.

20. The flying height control device for a magnetic head according to claim 19, wherein the control circuit increases the heater power when judging that the read error rate has not improved.
